(19) United States
(12) Patent Application Publication
(10) Pub. No.: US 2019/0266901 A1
(43) Pub. Date: Aug. 29, 2019

(54) SYSTEMS AND METHODS FOR ASSISTING UNMANNED VEHICLES IN DELIVERY TRANSACTIONS

(71) Applicant: Walmart Apollo, LLC, Bentonville, AR (US)

(72) Inventors: Brian McHale, Oldham (GB); Joseph Jurich, Molino, FL (US); Todd Mattingly, Bentonville, AR (US)

(21) Appl. No.: 16/288,284

(22) Filed: Feb. 28, 2019

Related U.S. Application Data
(60) Provisional application No. 62/636,717, filed on Feb. 28, 2018.

(51) Int. Cl. G08G 5/00; B64C 39/02; B64D 47/08; G05D 1/00; G01C 21/00; G01C 21/20; G06K 9/00

(52) U.S. Cl. CPC G08G 5/0069; B64C 39/024; B64D 47/08; G05D 1/0088; G01C 21/005; B64C 2201/123; G08G 5/0008; G08G 5/0034; G06K 9/00771; G06K 9/0063; B64C 2201/128; G01C 21/20

(57) ABSTRACT

Systems, methods and device for assisting in a delivery transaction. The system can include a scout unmanned aerial vehicle comprising a processor, a memory storage device in communication with the processor, and an imaging source in communication with the processor. The imaging source can monitor a geographical area within a predefined distance from a location that an unmanned vehicle is to deliver a product. The processor can determine an optimal path within the geographical area for the unmanned vehicle to deliver the product the location based on the monitoring of the geographical area. Methods and devices similar to such a system are also disclosed herein.

### CROSS-REFERENCED TO RELATED APPLICATION

This application claims the benefit of U.S. Provisional Patent Application No. 62/636,717, filed Feb. 28, 2018, which is incorporated herein by reference in its entirety.

### BACKGROUND

### 1. Technical Field

The present disclosure relates to systems and methods for assisting various unmanned vehicles in delivery transactions, and more specifically, doing so utilizing one or more scout unmanned aerial vehicles.

### 2. Introduction

Typically, after receiving an order for a product, a central server sends a delivery location and route information to an unmanned vehicle. The unmanned vehicle thereafter travels to the delivery location with the product according to the route provided by the central server. However, a number of problems may arise while the unmanned vehicle is in route to the delivery location. First, the route provided by the central server may no longer be the quickest/best way to get the delivery location. Second, the delivery of the product may no longer be feasible and/or recommended due to a number of factors beyond control of the central server and/or unmanned vehicle. Third, there may be no way to confirm receipt of the product by a consumer that ordered the product. Embodiments of the present invention solve these problems in a number of ways using a scout unmanned aerial vehicle.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media a technical solution to the technical problem described. In an example embodiment of the present invention, a scout unmanned aerial vehicle for assisting in a delivery transaction can include: a processor; a memory storage device in communication with the processor; and an imaging source in communication with the processor. The imaging source can monitor a geographical area within a predefined distance from a location that a vehicle is to deliver a product. The processor can determine an optimal path within the geographical area for the unmanned vehicle deliver the product the location based on the monitoring of the geographical area.

In another example embodiment of the present invention, a system for assisting in a delivery transaction is provided, including a first scout unmanned aerial vehicle having a processor, a memory storage device in communication with the processor, and an imaging source in communication with the processor. The imaging source monitors a geographical area within a predefined distance from a location that an unmanned vehicle is to deliver a product. The processor determines an optimal path within the geographical area for the unmanned vehicle to deliver the product the location based on the monitoring of the geographical area based on the monitoring of the geographical area.

In yet another example embodiment of the present invention, a method of assisting in a delivery transaction is provided, including: (i) receiving, via a processor, a geographical area for a first unmanned aerial vehicle to scout, wherein the geographical area is within a predefined distance from a location that an unmanned vehicle is to deliver a product; (ii) monitoring, via a imaging source, the geographical area; and (iii) determining, via the processor, an optimal path within the geographical area for the unmanned vehicle to deliver the product the location based on the monitoring of the geographical area.

### BRIEF DESCRIPTION OF THE DRAWINGS

FIG. 1 illustrates a system for assisting an unmanned vehicle in a delivery transaction in accordance with embodiment of the present invention;

FIG. 2 illustrates an unmanned aerial vehicle that can assist an unmanned vehicle in a delivery transaction in accordance with embodiments of the present invention;

FIG. 3 illustrates an exemplary method for assisting in a delivery transaction in accordance with embodiments of the present invention; and

FIG. 4 illustrates an exemplary computer system in accordance with embodiment of the present invention.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure. It is also important to note that any reference in the specification to “one embodiment,” “an embodiment” or “an alternative embodiment” means that a particular feature, structure or characteristic described in connection with the embodiment is included in at least one embodiment of the invention. As such, the recitation of “in one embodiment” and the like throughout the specification does not necessarily refer to the same embodiment.

The methods and systems disclosed herein are directed to assisting in a delivery transaction provided to an unmanned vehicle, such as an automated guided vehicle (“AGV”) and an unmanned aerial vehicle (“UAV”). To do so, the methods and systems can utilize one or more scout UAVs. As will be described in more detail below, the scout UAVs can operate independently from the unmanned vehicles, and directly or indirectly, provide appropriate information to the unmanned vehicles and/or a central server.

The term “unmanned vehicle,” as used herein, can refer to a vehicle without an individual onboard. As such, unmanned vehicles can be a remote controlled vehicle, a remotely guided vehicle, or an autonomous vehicle.

The term “automated guided vehicle” (“AGV”) as used herein, can refers to a robot that is capable of sensing their own environment and navigating on its own. For example, an AGV can follow markers or wires placed on, or located in, a floor for navigation. An AGV can also use vision, magnets or lasers for navigation.

The term, “unmanned aerial vehicle” (“UAV”), as used herein, can refer to an aircraft without an individual onboard.

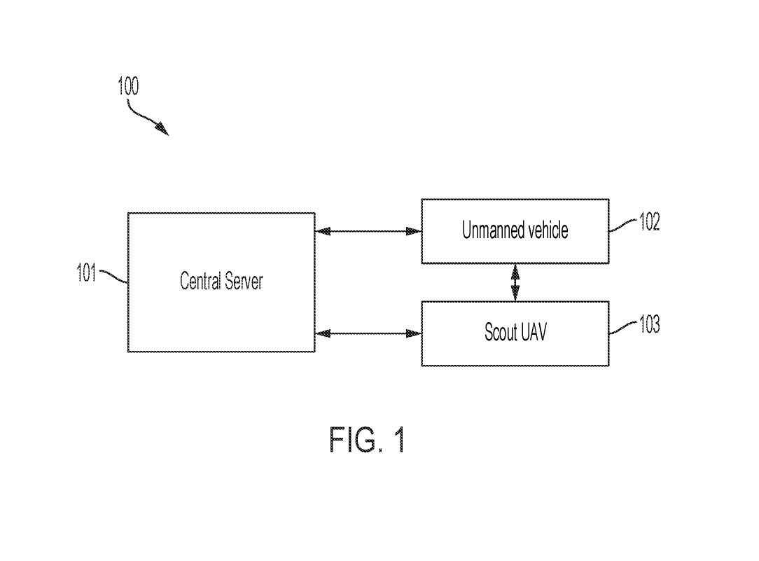

Referring now to the figures, various embodiments of systems and methods for assisting in a delivery transaction will be disclosed. Referring now to FIG. 1, a system 100 for assisting an unmanned vehicle 102 in a delivery transaction is provided. The system 100 can include a central server 101, an unmanned vehicle 102 in communication with the central server 101, and one or more scout UAVs 103 each in communication with the central server 101 and/or unmanned vehicle 102. The unmanned vehicle 102 can be a UAV or AGV, as stated above. The scout UAVs 103 can each be smaller than the unmanned vehicle 102. For instance, the scout UAVs 103 can be one-tenth the size of the unmanned vehicle. Along these lines, the scout UAVs 103 can mirror a structure and/or size of a dragonfly. As such, the scout UAVs 103 can have a pair of wings for propulsion, flight and/or ability to hover.

The system 100 can be implemented on a network-accessible computing platform. The system 100 can utilize a mesh network (not shown), which may include satellite-based navigation system or a terrestrial wireless network, Wi-Fi, and other type of wired or wireless networks to facilitate communications between the devices in the system 100. The central server 101 may be include one or more processors and memory which may be utilized to communicate with the unmanned vehicle 102 and scout UAV 103, as will be discussed herein.

The central server 101 can receive an order from an individual for one or more products. According to an embodiment, the order can be an online order. As such, the order can be placed on a merchant's website or on a mobile application linked to the merchant. According to another embodiment, the order can be placed at a brick and mortar store that belongs to, or is affiliated with, the merchant. In either embodiment, to place an order, the central server 101 can permit a customer to create an account profile. The account profile can store data related to the customer, including customer's username, email address, password, phone number, customer's rating, delivery address, payment transaction accounts, purchasing preference, search history, order history, information, other relevant demographic or analytical data, third parties including family members, friends, or neighbors, etc.

Upon receipt of an order, the central server 101 can determine a delivery location for the product. Along these lines, the central server 101 can determine an appropriate unmanned vehicle 102 based on the delivery location and/or one or more properties of the product. The properties of the product can include a weight of the product, dimensions of the product, and special characteristics of the product (e.g., delicate, temperature). As such, the central server 101 can determine if the product should be delivered by an UAV and/or AGV, and can determine a type thereof.

Moreover, the central server 101 can determine an appropriate route for the unmanned vehicle 102 to take to the delivery location. To determine the appropriate route, the central server 101 can receive geographical information. The geographical information can be received via one or more application program interfaces (“APIs”). The APIs can provide interfaces to Uber®, Lyft®, Waze®, TomTom®, Magellan®, UPS®, FedEx®, Amazon®, and Google®. The geographical information received from these third party providers can depend on a type of the unmanned vehicle. For example, when the unmanned vehicle is a UAV, only UPS®, FedEx®, Amazon®, and Google® may be able to provide geographical information that can be utilized in traveling in the sky. Alternatively, when the unmanned vehicle is an AGV, only Uber®, Lyft®, Waze®, TomTom®, Magellan® may be able to provide geographical information that can be utilized in traveling on ground.

Along these lines, the central server can determine a confidence level for each of the information sources. The confidence level can be based on age of the data, historical reliability of the data, time of last update of the data, and an amount of data provided for a specific geographical region. For example, a particular data source may update more frequently, provide more accurate data, or have more data in a particular geographical region. As such, the central server can determine which information to utilize in determining the appropriate route. Upon determining the appropriate route, the central server 101 can transmit it to the unmanned vehicle 102.

In addition, the central server 101 can be in communication with one or more scout UAVs 103. The central server 101 and/or the unmanned vehicle 102 can transmit the route of the unmanned vehicle 102 to the scout UAVs 103. The scout UAVs 103 can then determine a recommended route for a portion of the main route assigned to the unmanned vehicle 102 by the central server 101. The route recommended by the scout UAVs 103 can be any portion of the main route assigned to the unmanned vehicle 102. According to an embodiment, the recommend route is a “last leg,” or an end portion, of the main route recommended by the central server 101. As such, the recommend route can be within a predetermined distance from the delivery destination (e.g., 25 ft., 50 ft., and 100 ft.).

Along these lines, the central server 101 can deploy the scout UAVs 103 at a same time, prior to, or after determination of the delivery location. As such, according to an embodiment, the scout UAVs 103 can be located at a base station. The base station can be different or the same as a location that the unmanned vehicles 102 are stored. Along these lines, the base station can be closer to, or further away from, a geographical region that the scout UAVs are to be deployed. According to another embodiment, the scout UAVs 103 can already be deployed in a geographical region prior to the determination of the delivery location. As such, the scout UAVs 103 may scout a geographical area for multiple unmanned vehicles, prior to and after the unmanned vehicle 102.

Moreover, the central server 101 can assign the scout UAVs 103 to a particular geographical region. The geographical region can be a city, a zip code, a county, a neighborhood, or a region. Along these lines, the geographical region can be a predefined distance (e.g., 1 mi., 5 mi., or 10 mi.) from a location, such as a national or local landmark, the delivery location, a place in which the unmanned vehicle 102 is deployed, and a place in which the scout UAVs 103 are deployed.

Furthermore, the number of scout UAVs 103 assigned to a geographical region can depend on one or more factors relating to the geographical region. Factors of the geographical region can include a population density of the geographical region (e.g., people per square mile), a number of products being delivery for the geographical area, and a number of high-value products being delivered to the geographical area. As such, according to an embodiment, the higher that the population density is in a particular geographical region, the more scout UAVs 103 are utilized in the geographical region. As such, more scout UAVs 103 can be provided for urban areas than for suburban areas. For example, more scout UAVs 103 can be utilized in New York, N.Y., than scout UAVs 103 utilized in Omaha, Nebr. or within smaller geographical regions (e.g. zip codes or neighborhoods). By providing additional scout UAVs 103 in areas having higher population densities, added obstacles/impediments that the scout UAVs 103 may encounter can be accounted for and overcome.

According to another embodiment, the more products are delivered to a particular geographical area, the more scout UAVs 103 are assigned to the geographical area. This can be accomplished regardless of the population density of the geographical area. According to yet another embodiment, the more high-value products are delivered to a geographical area, the more scout UAVs 103 are assigned to the geographical area. The number of high-value products being delivered to the geographical area can be much lower than the total number of products being delivered to the geographical area. As such, an increased number of scout UAVs 103 can be assigned to a particular geographical area, although a total number of products being delivered to the geographical area is not as high.

Additionally, the scout UAVs 103 can continually monitor the geographical region in real-time for a period of time, including prior to and/or during a time that the unmanned vehicle's 102 travels to the delivery destination. For example, the scout UAVs 103 can be assigned to monitor the geographical region prior to unmanned vehicle 102 was assigned to deliver the product to the delivery location. By being assigned to various geographical regions, the scout UAVs 103 can provide a recommended route within the geographical region to the unmanned vehicle 102. The recommended path can be an optimal path, which can be different and/or quicker than the route assigned to the unmanned vehicle 102 by the central server 101. In some cases, the unmanned vehicle 102 may not be provided with the last leg of the trip, and may be provided with this information from the scout UAVs 103.

To determine an optimal path, the scout UAVs 103 can receive geographical information in the same fashion as the central server 101, as described above. As such, according to an embodiment, when the unmanned vehicle 102 is a UAV, the scout UAVs 103 can determine an appropriate air path for the UAV delivering the product to the delivery location. According to another embodiment, when the unmanned vehicle 102 is a AGV, the scout UAVs 103 can assist the AGV is getting to the delivery location quicker by, for example, avoiding traffic, construction, and/or left turns.

Along these lines, the scout UAVs 103 can also determine a possibility of successful delivery by the unmanned vehicle 102. The possibility of successful delivery can be based on a risk level of not successfully delivering the product. According to an embodiment, the risk level can be based on information relating to the geographical area that the scout UAV 103 is monitoring or to a portion thereof (e.g., a neighborhood of the delivery location). The information can include crime statistics, past stolen products in the geographical area and/or delivery location, hours of operation of the delivery location, and a time of day. According to another embodiment, the risk level can also be based on identification of a suspect vehicle (e.g., those having known license plates), an individual (e.g., those who are crime suspects or have committed a crime), or a delivery location (e.g., geographical area, building, residence). According to yet another embodiment, the risk level can be based on unexpected transmission signals, such as WI-FI®, Bluetooth®, or any other radio frequency emissions. In any of the aforementioned embodiments, the scout UAVs 103 and/or the central server 101 can receive the appropriate information from the data sources discussed above. Additional data sources can include those of a crime authority (i.e., local police, state police, and court records) and of social media platforms (e.g., Facebook®, Twitter®, YouTube®, and Twitter®). Moreover, the scout UAVs 103 and/or central server 101 can assign a confidence level to the data sources. The confidence level can determine which data source is the most trustworthy to utilize, as discussed above. As such, the risk level can be dynamic. The scout UAV 103 and/or the central server 101 can assign a particular risk level to different areas and/or objects within the geographical region.

Furthermore, the scout UAVs 103 can determine the possibility of successful delivery and/or the optimal path for the unmanned vehicle 102 based on previous deliveries. The previous deliveries can be by the same scout UAV or a different scout UAV. Moreover, the previous deliveries can be to the same delivery location, or to a delivery location within a vicinity to the delivery location (e.g., 0.5 mi., 1 mi., and 5 mi.). As such, the scout UAVs 103 can continually improve its accuracy in determining the possibility of successful delivery and/or recommend, optimal route for the unmanned vehicle 102. Moreover, the scout UAVs 103 can share the possibility of successful delivery and/or the optimal path with other scout UAVs and/or the central server 101 to improve the system.

Along these lines, the scout UAVs 103 can analyze one or more properties of the delivery location. The properties of the delivery location can include one or more of a type of delivery location (e.g., residential, commercial, government, religious, etc.), an orientation of the delivery location, and a preferred location for delivery of a product. The scout UAVs 103 can share the properties of the delivery location with other scout UAVs and/or the central server 101 to improve the system.

Upon the scout UAVs 103 determining the possibility of a successfully delivery and/or the optimal path for the unmanned vehicle 101, the scout UAVs 103 can transmit such directly to the unmanned vehicle 102. Alternatively, the scout UAVs 103 can transmit the possibility and/or the optimal path to the central server 101. The central server 101 can then determine whether or not to transmit the possibility and/or the optimal path to the unmanned vehicle 102.

Moreover, when the unmanned vehicle 102 enters the geographical area that the scout UAVs 103 is monitoring, the scout UAVs 103 can attach onto, and piggyback on, the unmanned vehicle 102. To do so, the unmanned vehicle 102 and/or the scout UAVs 103 can comprise one or more coupling mechanisms. The scout UAVs 103 may also have attached onto, and piggybacked on, the unmanned vehicle 102 at the start of its mission, or joined at any other time on its mission. While attached to the unmanned vehicle 102, the scout UAVs 103 can receive a charge from the unmanned vehicle 102. The scout UAVs 103 can then remain attached to the unmanned vehicle 102 until such time that the unmanned vehicle 102 arrives at the delivery location.

Upon arrival to the delivery location, the scout UAVs 103 can remain attached to the unmanned vehicle 102, or it can detach from the unmanned vehicle 102. The scout UAVs 103 can then scout the delivery location. As such, the scout UAVs 103 can determine a location, and/or if it is appropriate, to unload the product at the delivery location. Along these lines, the scout UAVs 103 can determine if there are one or more impediments in unloading the product at the delivery location. Appropriateness of unloading the product at the delivery location can be based on information related to the delivery location including, for example, one or more of crime statistics at the delivery location, past stolen products at the delivery location, hours of operation of the delivery location, identification of unknown or suspect cars or individuals, and a time of day.

Additionally, the scout UAVs 103 can record the unmanned vehicle 102 unloading the product to the delivery location, and/or can remain at the delivery location until the receipt of the product. As such, the scout UAVs 103 can record an identity of an individual receiving the product. The recording of the unloading of the product and/or the receipt of the product can be based on information relating to the geographical area surrounding the delivery destination and/or to the delivery location itself. The information relating to the geographical area and/or delivery destination can include one or more of crime statistics in the geographical area or at the delivery location, past stolen products in the geographical area or at the delivery location, hours of operation of the delivery location, identification of unknown or suspect cars or individuals in the geographical area (or a portion of the geographical area) or at the delivery location, and a time of day.

Furthermore, while the scout UAVs 103 remain with the package, the scout UAVs 103 can recharge from within a customer's locker or a tower system. Upon receipt of the package, the scout UAVs 103 can continue to monitor the geographical area or return to their base. If the scout UAVs 103 are to return to their base, they can fly themselves, or can piggyback on an unmanned vehicle 102 or another unmanned vehicle. The unmanned vehicle carrying the scout UAV 103 can be inside or outside the geographical area. As such, the unmanned vehicle carrying the scout UAV 103 can go to the delivery location and pick-up the scout UAV 103, or the scout UAV 103 can fly to the unmanned vehicle to piggyback thereon.

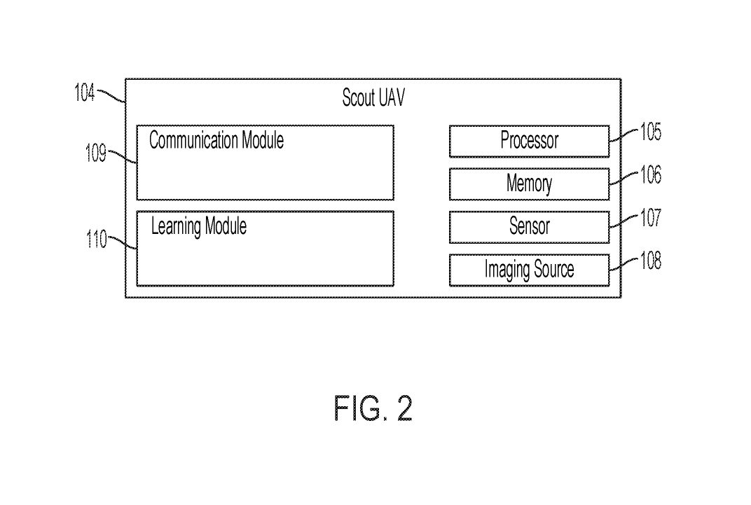

Referring now to FIG. 2, an exemplary scout UAV 104 that can deployed in embodiments of the present invention is illustrated. The scout UAV 104 can comprise a processor 105, as well as a memory storage device 106, one or more sensors 107, and one or more imaging sources 108 each of which are in communication with the processor 105. The sensors 107 can determine information on the internal and/or external state of the unmanned aerial vehicle 121. As such, the sensors 107 can determine the position and movement of the scout UAV 104, any other scout UAVs, and the unmanned vehicle 102 (illustrated in FIG. 1). The imaging source 108 can permit recording of geographical information and/or objects in a geographical region of interest. As such, the imaging source 108 can be any device capable of providing an image, including, for example, a camera.

Moreover, the scout UAV 104 comprises a communication module 109 and a learning module 110. The communication module 122 can permit communication with another scout UAV, the unmanned vehicle 102 (illustrated in FIG. 1), and/or the central server 101 (depicted in FIG. 1). For example, the communication module 122 can include an antenna, a signal amplifier, a signal up converter or signal down converter, an encoder and a decoder (or other mechanism for modulation/demodulation of the signal), as well as any additional processors needed to process the signal before being either transmitted to the unmanned vehicle 102 and/or the central server 101, or before transmitting a received signal to the scout UAV 104 processor 105 for analysis. The learning module 110 can permit the scout UAV 104 to learn from past missions of the scout UAV 104 and/or other scout UAVs. As such, the components of the scout UAV 104 perform the functions described above with respect to scout UAV 103 (shown in FIG. 1). More specifically, the learning module 110 can contain a database which stores mission data from previous missions conducted by the scout UAV 103, or mission data from previous missions conducted by other scout UAVs, the unmanned vehicle 102, other unmanned vehicles. The learning module 110 can also store and/or access, through use of one or more databases, other resources such as satellite data, traffic cameras, social media feeds, or other camera resources. The learning module 110 can further contain at least one processor to analyze the current mission data, in combination with data from previous missions for this location and other locations, and identify improvements in how the scouting/routing can be performed in future iterations.

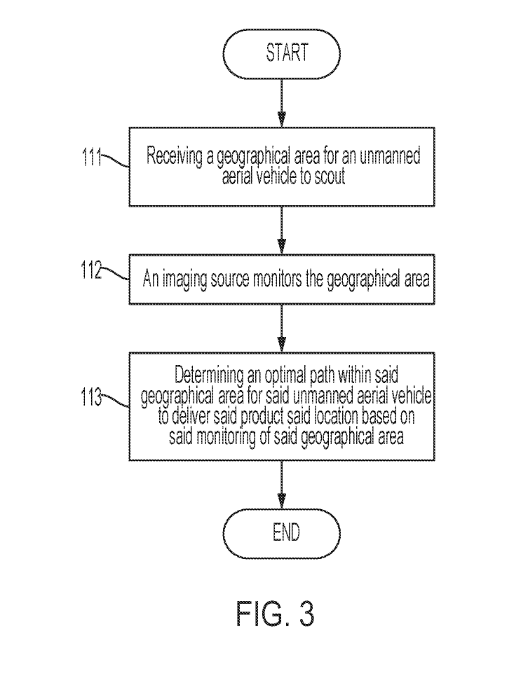

Referring now to FIG. 3, an exemplary method for assisting in a delivery transaction is provided. First, at step 111, a processor receives a geographical area for an unmanned aerial vehicle to scout. The geographical area is within a predefined distance from a location that an unmanned aerial vehicle is to deliver a product. Thereafter, at step 112, an imaging source monitors the geographical area. Subsequently, at step 113, the processor determines an optimal path within the geographical area for the unmanned aerial vehicle to deliver the product the location based on the monitoring of the geographical area. Each of the aforementioned steps can be performed in accordance with embodiments of the present invention as described above.

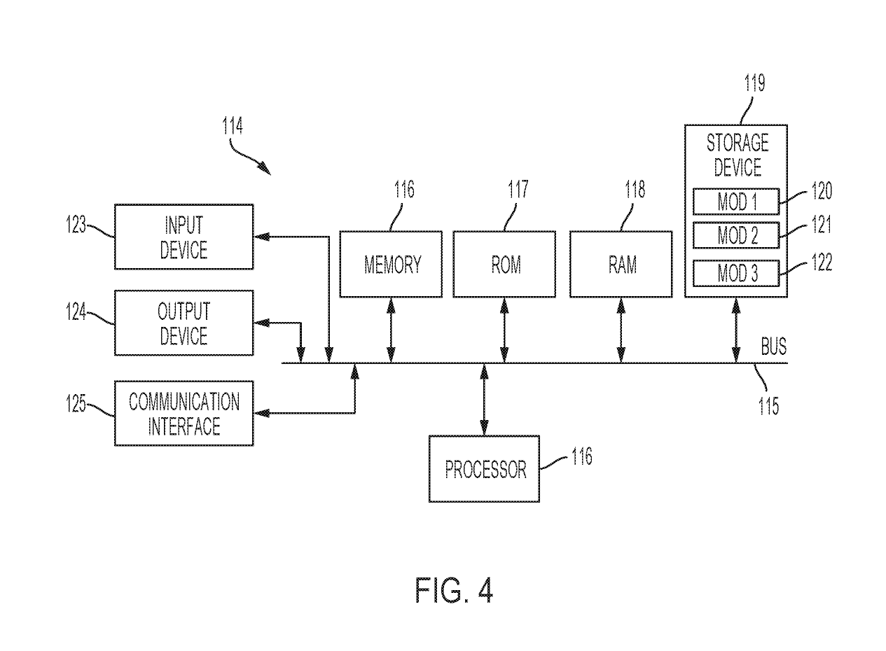

Referring now to FIG. 4, an exemplary system 114 for present invention is illustrated. The system 114 can include a general-purpose computing device, and can include a processing unit (CPU or processor) 116 and a system bus 115 that couples various system components including the system memory 117 such as read-only memory (ROM) 118 and random access memory (RAM) 119 to the processor 116. The system 114 can include a cache of high-speed memory connected directly with, in close proximity to, or integrated as part of the processor 116. The system 114 copies data from the memory 117 and/or the storage device 119 to the cache for quick access by the processor 116. In this way, the cache provides a performance boost that avoids processor 116 delays while waiting for data. These and other modules can control or be configured to control the processor 116 to perform various actions. Other system memory 117 may be available for use as well. The memory 117 can include multiple different types of memory with different performance characteristics. It can be appreciated that the disclosure may operate on a computing device with more than one processor 116 or on a group or cluster of computing devices networked together to provide greater processing capability. The processor 116 can include any general purpose processor and a hardware module or software module, such as module-1 120, module-2 121, and module-3 122 stored in storage device 119, configured to control the processor 116 as well as a special-purpose processor where software instructions are incorporated into the actual processor design. The processor 116 may essentially be a completely self-contained computing system, containing multiple cores or processors, a bus, memory controller, cache, etc. A multi-core processor may be symmetric or asymmetric.

The system bus 115 may be any of several types of bus structures including a memory bus or memory controller, a peripheral bus, and a local bus using any of a variety of bus architectures. A basic input/output (BIOS) stored in ROM 118 or the like, may provide the basic routine that helps to transfer information between elements within the system 114, such as during start-up. The system 114 can also include storage devices 119 such as a hard disk drive, a magnetic disk drive, an optical disk drive, tape drive or the like. The storage device 119 can include software modules 120, 121, 122 for controlling the processor 116. Other hardware or software modules are contemplated. The storage device 119 is connected to the system bus 115 by a drive interface. The drives and the associated computer-readable storage media provide nonvolatile storage of computer-readable instructions, data structures, program modules and other data for the system 114. In one aspect, a hardware module that performs a particular function includes the software component stored in a tangible computer-readable storage medium in connection with the necessary hardware components, such as the processor 116, bus 115, display 124, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of computing device that the system 114 is implemented, such as whether the computing device is a small, handheld computing device, a desktop computer, or a computer server.

Although the exemplary embodiment described herein employs the hard disk 119, other types of computer-readable media which can store data that are accessible by a computer, such as magnetic cassettes, flash memory cards, digital versatile disks, cartridges, random access memories (RAMs) 119, and read-only memory (ROM) 118, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 114, an input device 123 represents any number of input mechanisms, such as a microphone for speech, a touch-sensitive screen for gesture or graphical input, keyboard, mouse, motion input, speech and so forth. An output device 124 can also be one or more of a number of output mechanisms known to those of skill in the art. In some instances, multimodal systems enable a user to provide multiple types of input to communicate with the computing device 114. The communications interface 125 generally governs and manages the user input and system output. There is no restriction on operating on any particular hardware arrangement and therefore the basic features here may easily be substituted for improved hardware or firmware arrangements as they are developed.

From the foregoing description, one skilled in the art can readily ascertain the essential characteristics of the invention, and without departing from the spirit and scope thereof, can make changes and modifications of the invention to adapt it to various conditions and to utilize the present invention to its fullest extent. The specific embodiments described here are to be construed as merely illustrative, and not limiting of the scope of the invention in any way whatsoever. Moreover, features described in connection with one embodiment of the invention may be used in conjunction with other embodiments, even if not explicitly stated above.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A scout unmanned aerial vehicle for assisting in a delivery transaction, comprising:
a processor;
a memory storage device in communication with the processor; and
an imaging source in communication with the processor,
wherein the imaging source monitors a geographical area within a predefined distance from a location that an unmanned vehicle is to deliver a product, and
wherein the processor determines an optimal path within the geographical area for the unmanned vehicle to deliver the product to the location based on the monitoring of the geographical area.

2. The scout unmanned aerial vehicle of claim 1, wherein the unmanned vehicle is one of an unmanned aerial vehicle or an automated guided vehicle.

3. The scout unmanned aerial vehicle of claim 1, additionally comprising:
a communication module which communicates with the unmanned vehicle delivering the product to the location,
wherein the communication module sends the optimal path to the unmanned vehicle delivering the product to the location or to a central server.

4. The scout unmanned aerial vehicle of claim 1, additionally comprising:
a content management module in communication with the processor and the imaging source,
wherein the content management module receives geographical information for the geographical area from one or more application program interfaces.

5. The scout unmanned aerial vehicle of claim 4, wherein the processor determines a confidence level for geographical information received from each of the one or more application program interfaces.

6. The scout unmanned aerial vehicle of claim 5, wherein the confidence level is based on one or more of an age and a historical reliability of geographical information received from each of the one or more application program interfaces.

7. The scout unmanned aerial vehicle of claim 5, wherein the processor aggregates geographical information of the geographical area received from a plurality of application program interfaces based on the confidence level.

8. The scout unmanned aerial vehicle of claim 4, wherein the processor determines one or more suspicious activities based on geographical information of the geographical area received from one or more application program interfaces.

9. The scout unmanned aerial vehicle of claim 8, wherein the suspicious activity includes a crime rate, a suspicious individual, a suspicious vehicle, and an availability of an unexpected platform for exchanging data in one or more regions of the geographical area.

10. The scout unmanned aerial vehicle of claim 8, wherein the processor assigns a risk factor based on the one or more suspicious activities.

11. The scout unmanned aerial vehicle of claim 1, additionally comprising:
a learning module determines the optimal path for the unmanned vehicle delivering the product to the location based on previous monitoring of the geographical area.

12. The scout unmanned aerial vehicle of claim 1, wherein the imaging source monitors the location that the product is delivered to by the unmanned vehicle.

13. The scout unmanned aerial vehicle of claim 12, wherein the imaging source records an individual receiving the product delivered to the location by the unmanned vehicle.

14. The scout unmanned aerial vehicle of claim 1, additionally comprising:
a mechanism to couple to the scout unmanned aerial vehicle to the unmanned vehicle,
wherein the processor instructs the scout unmanned aerial vehicle to couple to the unmanned vehicle during the delivery of the product to the location.

15. A system for assisting in a delivery transaction, comprising:
a first scout unmanned aerial vehicle comprising:
a processor;
a memory storage device in communication with the processor; and
at least one imaging source in communication with the processor,
wherein the at least one imaging source monitors a geographical area within a predefined distance from a location that an unmanned vehicle is to deliver a product, and
wherein the processor determines an optimal path within the geographical area for the unmanned vehicle to deliver the product to the location based on the monitoring of the geographical area.

16. The system of claim 15, additionally comprising:
a second scout unmanned aerial vehicle comprising:
a processor;
a memory storage device in communication with the processor; and
an imaging source in communication with the processor,
wherein the imaging source monitors a geographical area within a predefined distance from a location that an unmanned vehicle is to deliver a product, and
wherein the processor determines an optimal path within the geographical area for the unmanned vehicle to deliver the product to the location based on the monitoring of the geographical area.

17. The system of claim 16, wherein the geographical area monitored by the first scout unmanned aerial vehicle is different than the geographical area monitored by the second scout unmanned aerial vehicle such that the first scout unmanned aerial vehicle and the second scout unmanned aerial vehicle determine different optimal paths spanning different geographical areas for the unmanned vehicle delivering of the product to the location.

18. The system of claim 16, wherein, when the geographical area is a high density geographical area, the first scout unmanned aerial vehicle monitors the same geographical area as the second scout unmanned aerial vehicle.

19. The system of claim 16, wherein each of the first scout unmanned aerial vehicle and the second scout unmanned aerial vehicle additionally comprise a communicative device, and wherein the first scout unmanned aerial vehicle is in communication with the second scout unmanned aerial vehicle.

20. A method for assisting in a delivery transaction, comprising:
receiving, via a processor, a geographical area for a first unmanned aerial vehicle to scout, wherein the geographical area is within a predefined distance from a location that an unmanned aerial vehicle is to deliver a product;
monitoring, via a imaging source, the geographical area; and
determining, via the processor, an optimal path within the geographical area for the unmanned aerial vehicle to deliver the product the location based on the monitoring of the geographical area.
